(19) United States
(12) Patent Application Publication
(10) Pub. No.: US 2025/0227230 A1
(43) Pub. Date: Jul. 10, 2025

(54) DEVICE AND METHOD FOR DECODING VIDEO DATA

(71) Applicant: SHARP KABUSHIKI KAISHA, Sakai City (JP)

(72) Inventors: Yu-Chiao Yang, Taipei (TW); Chih-Yu Teng, Taipei (TW)

(21) Appl. No.: 19/009,201

(22) Filed: Jan. 3, 2025

Related U.S. Application Data
(60) Provisional application No. 63/618,081, filed on Jan. 5, 2024.

(51) Int. Cl. H04N 19/117; H04N 19/176; H04N 19/186; H04N 19/80

(52) U.S. Cl. CPC H04N 19/117; H04N 19/176; H04N 19/186; H04N 19/80

(57) ABSTRACT

A method of decoding video data is provided. The method includes: determining, from an image frame of the video data, a chroma block unit and a luma collocated block, that is collocated with the chroma block unit; determining a luma collocated vector of the luma collocated block; determining, from the image frame, a first luma candidate block based on the luma collocated vector; determining a first luma candidate vector of the first luma candidate block; determining, from the image frame, a first luma relocated block based on the first luma candidate vector; determining, from the image frame, a chroma relocated block corresponding to the first luma relocated block; deriving a cross-component filter based on the first luma relocated block and the chroma relocated block; and reconstructing the chroma block unit based on the luma collocated block using the cross-component filter. Furthermore, an electronic device using the method is also provided.

### CROSS-REFERENCE TO RELATED APPLICATION(S)

The present disclosure claims the benefit of and priority to U.S. Provisional Patent Application Ser. No. 63/618,081, filed on Jan. 5, 2024, entitled “RELOCATED CANDIDATE DERIVATION FOR GENERATING PREDICTION,” the content of which is hereby incorporated herein fully by reference in its entirety for all purposes.

### FIELD

The present disclosure generally relates to video coding, and more specifically, to techniques for predicting a chroma block unit of a block unit using a cross-component filter of the block unit, which is determined based on a relocated vector of the block unit.

### BACKGROUND

Cross-component prediction (CCP) mode is a chroma coding tool for video coding, in which, an encoder and/or a decoder may predict a chroma block of a current block based on a luma block of the current block by using a prediction model.

In addition, the encoder and/or the decoder may derive the prediction model of the chroma block based on a luma vector of the luma block generated prior to the reconstruction of the chroma block. A reference block indicated by the luma vector, however, may be just an intermediate reference, but not provide original information as the reference. Thus, the prediction model of the chroma block derived based on the reference block may be inadequate to predict all of several chroma samples in the chroma block.

Thus, model refinement modes may be required for the encoder and/or the decoder to be able to precisely and efficiently predict and/or reconstruct the chroma block of the block unit.

### SUMMARY

The present disclosure is directed to a device and method for predicting a chroma block unit of a block unit by using a cross-component filter, derived based on a chroma relocated vector of a chroma block unit.

In a first aspect of the present disclosure, a non-transitory machine-readable medium of an electronic device storing one or more computer-executable instructions for decoding video data is provided. The one or more computer-executable instructions, when executed by at least one processor of the electronic device, cause the electronic device to: receive the video data; determine, from an image frame of the video data, a chroma block unit and a luma collocated block that is collocated with the chroma block unit; determine a luma collocated vector of the luma collocated block; determine, from the image frame, a first luma candidate block based on the luma collocated vector of the luma collocated block; determine a first luma candidate vector of the first luma candidate block; determine, from the image frame, a first luma relocated block based on the first luma candidate vector of the first luma candidate block; determine, from the image frame, a chroma relocated block corresponding to the first luma relocated block; derive a cross-component filter based on the first luma relocated block and the chroma relocated block; and reconstruct the chroma block unit based on the luma collocated block using the cross-component filter.

In an implementation of the first aspect of the present disclosure, the one or more computer-executable instructions, when executed by at least one processor of the electronic device, further cause the electronic device to: determine, from the image frame, a second luma candidate block based on the first luma candidate vector of the first luma candidate block; determine a second luma candidate vector of the second luma candidate block; and determine, from the image frame, the first luma relocated block further based on the second luma candidate vector of the second luma candidate block.

In another implementation of the first aspect of the present disclosure, the first luma candidate vector of the first luma candidate block indicates the first luma relocated block from the first luma candidate block.

In another implementation of the first aspect of the present disclosure, deriving the cross-component filter based on the first luma relocated block and the chroma relocated block comprises: determining a luma scaled block based on the first luma relocated block using one of a down-sampling filter and a sub-sampling filter; and deriving the cross-component filter based on the luma scaled block and the chroma relocated block.

In another implementation of the first aspect of the present disclosure, determining, from the image frame, the chroma relocated block corresponding to the first luma relocated block comprises: determining a luma relocated vector based on the luma collocated vector of the luma collocated block and the first luma candidate vector of the first luma candidate block; determining a chroma relocated vector by scaling the luma relocated vector for determining the cross-component filter; and determining the chroma relocated block based on the chroma relocated vector.

In another implementation of the first aspect of the present disclosure, determining, from the image frame, the chroma relocated block corresponding to the first luma relocated block comprises: determining, from the image frame, a chroma collocated block collocated with the first luma relocated block as the chroma relocated block.

In another implementation of the first aspect of the present disclosure, the one or more computer-executable instructions, when executed by the at least one processor, further cause the electronic device to: determine a second luma candidate vector of the first luma candidate block; determine, from the image frame, a second luma candidate block based on the second luma candidate vector of the first luma candidate block; determine a second luma candidate vector of the second luma candidate block; and determine, from the image frame, a second luma relocated block based on the second luma candidate vector of the second luma candidate block, wherein: the first luma relocated block and the second luma relocated block are included in a plurality of relocated candidates, and in a case that the first luma relocated block is selected from the plurality of relocated candidates to reconstruct the chroma block unit, the chroma relocated block is determined based on the first luma relocated block.

In a second aspect of the present disclosure, an electronic device for decoding video data is provided. The electronic device includes at least one processor and one or more non-transitory computer-readable media that are coupled to the at least one processor. The one or more non-transitory computer-readable media store one or more computer-executable instructions that, when executed by the at least one processor, cause the electronic device to: receive the video data; determine, from an image frame of the video data, a chroma block unit and a luma collocated block that is collocated with the chroma block unit; determine a luma collocated vector of the luma collocated block; determine, from the image frame, a first luma candidate block based on the luma collocated vector of the luma collocated block; determine a first luma candidate vector of the first luma candidate block; determine, from the image frame, a first luma relocated block based on the first luma candidate vector of the first luma candidate block; determine, from the image frame, a chroma relocated block corresponding to the first luma relocated block; derive a cross-component filter based on the first luma relocated block and the chroma relocated block; and reconstruct the chroma block unit based on the luma collocated block using the cross-component filter.

In an implementation of the second aspect of the present disclosure, the one or more computer-executable instructions, when executed by at least one processor of the electronic device, further cause the electronic device to: determine, from the image frame, a second luma candidate block based on the first luma candidate vector of the first luma candidate block; determine a second luma candidate vector of the second luma candidate block; and determine, from the image frame, the first luma relocated block further based on the second luma candidate vector of the second luma candidate block.

In another implementation of the second aspect of the present disclosure, the first luma candidate vector of the first luma candidate block indicates the first luma relocated block from the first luma candidate block.

In another implementation of the second aspect of the present disclosure, deriving the cross-component filter based on the first luma relocated block and the chroma relocated block comprises: determining a luma scaled block based on the first luma relocated block using one of a down-sampling filter and a sub-sampling filter; and deriving the cross-component filter based on the luma scaled block and the chroma relocated block.

In another implementation of the second aspect of the present disclosure, determining, from the image frame, the chroma relocated block corresponding to the first luma relocated block comprises: determining a luma relocated vector based on the luma collocated vector of the luma collocated block and the first luma candidate vector of the first luma candidate block; determining a chroma relocated vector by scaling the luma relocated vector for determining the cross-component filter; and determining the chroma relocated block based on the chroma relocated vector.

In another implementation of the second aspect of the present disclosure, determining, from the image frame, the chroma relocated block corresponding to the first luma relocated block comprises: determining, from the image frame, a chroma collocated block collocated with the first luma relocated block as the chroma relocated block.

In another implementation of the second aspect of the present disclosure, the one or more computer-executable instructions, when executed by the at least one processor, further cause the electronic device to: determine a second luma candidate vector of the first luma candidate block; determine, from the image frame, a second luma candidate block based on the second luma candidate vector of the first luma candidate block; determine a second luma candidate vector of the second luma candidate block; and determine, from the image frame, a second luma relocated block based on the second luma candidate vector of the second luma candidate block, wherein: the first luma relocated block and the second luma relocated block are included in a plurality of relocated candidates, and in a case that the first luma relocated block is selected from the plurality of relocated candidates to reconstruct the chroma block unit, the chroma relocated block is determined based on the first luma relocated block.

In a third aspect of the present disclosure, an electronic device for encoding video data is provided. The electronic device includes at least one processor and one or more non-transitory computer-readable media coupled to the at least one processor. The one or more non-transitory computer-readable media store one or more computer-executable instructions that, when executed by the at least one processor, cause the electronic device to: receive the video data; determine, from an image frame of the video data, a chroma block unit and a luma collocated block that is collocated with the chroma block unit; determine a luma collocated vector of the luma collocated block; determine, from the image frame, a first luma candidate block based on the luma collocated vector of the luma collocated block; determine a first luma candidate vector of the first luma candidate block; determine, from the image frame, a first luma relocated block based on the first luma candidate vector of the first luma candidate block; determine, from the image frame, a chroma relocated block corresponding to the first luma relocated block; derive a cross-component filter based on the first luma relocated block and the chroma relocated block; and reconstruct the chroma block unit based on the luma collocated block using the cross-component filter.

In an implementation of the third aspect of the present disclosure, the one or more computer-executable instructions, when executed by at least one processor of the electronic device, further cause the electronic device to: determine, from the image frame, a second luma candidate block based on the first luma candidate vector of the first luma candidate block; determine a second luma candidate vector of the second luma candidate block; and determine, from the image frame, the first luma relocated block based on the second luma candidate vector of the second luma candidate block.

In another implementation of the third aspect of the present disclosure, the first luma candidate vector of the first luma candidate block indicates the first luma relocated block from the first luma candidate block.

In another implementation of the third aspect of the present disclosure, deriving the cross-component filter based on the first luma relocated block and the chroma relocated block comprises: determining a luma scaled block based on the first luma relocated block using one of a down-sampling filter and a sub-sampling filter; and deriving the cross-component filter based on the luma scaled block and the chroma relocated block.

In another implementation of the third aspect of the present disclosure, determining, from the image frame, the chroma relocated block corresponding to the first luma relocated block comprises: determining a luma relocated vector based on the luma collocated vector of the luma collocated block and the first luma candidate vector of the first luma candidate block; determining a chroma relocated vector by scaling the luma relocated vector for determining the cross-component filter; and determining the chroma relocated block based on the chroma relocated vector.

In another implementation of the third aspect of the present disclosure, determining, from the image frame, the chroma relocated block corresponding to the first luma relocated block comprises: determining, from the image frame, a chroma collocated block collocated with the first luma relocated block as the chroma relocated block.

In another implementation of the third aspect of the present disclosure, the one or more computer-executable instructions, when executed by the at least one processor, further cause the electronic device to: determine a second luma candidate vector of the first luma candidate block; determine, from the image frame, a second luma candidate block based on the second luma candidate vector of the first luma candidate block; determine a second luma candidate vector of the second luma candidate block; and determine, from the image frame, a second luma relocated block based on the second luma candidate vector of the second luma candidate block, wherein: the first luma relocated block and the second luma relocated block are included in a plurality of relocated candidates, and in a case that the first luma relocated block is selected from the plurality of relocated candidates to reconstruct the chroma block unit, the chroma relocated block is determined based on the first luma relocated block.

### BRIEF DESCRIPTION OF THE DRAWINGS

Aspects of the present disclosure are best understood from the following detailed disclosure and the corresponding figures. Various features are not drawn to scale and dimensions of various features may be arbitrarily increased or reduced for clarity of discussion.

FIG. 1 is a block diagram illustrating a system having a first electronic device and a second electronic device for encoding and decoding video data, in accordance with one or more example implementations of this disclosure.

FIG. 2 is a block diagram illustrating a decoder module of the second electronic device illustrated in FIG. 1, in accordance with one or more example implementations of this disclosure.

FIG. 3 is a flowchart illustrating a method/process for decoding and/or encoding video data by an electronic device, in accordance with one or more example implementations of this disclosure.

FIGS. 4A and 4B are schematic illustrations of a block unit including a luma collocated block and a chroma block unit, in accordance with one or more example implementations of this disclosure.

FIGS. 5A and 5B are schematic illustrations of a luma frame and a chroma frame, in accordance with one or more example implementations of this disclosure.

FIG. 6 is a flowchart illustrating a method/process for decoding and/or encoding video data by an electronic device, in accordance with one or more example implementations of this disclosure.

FIG. 7 is a block diagram illustrating an encoder module of the first electronic device illustrated in FIG. 1, in accordance with one or more example implementations of this disclosure.

### DETAILED DESCRIPTION

The following disclosure contains specific information pertaining to implementations in the present disclosure. The figures and the corresponding detailed disclosure are directed to example implementations. However, the present disclosure is not limited to these example implementations. Other variations and implementations of the present disclosure will occur to those skilled in the art.

Unless noted otherwise, like or corresponding elements among the figures may be indicated by like or corresponding reference designators. The figures and illustrations in the present disclosure are generally not to scale and are not intended to correspond to actual relative dimensions.

For the purposes of consistency and ease of understanding, features are identified (although, in some examples, not illustrated) by reference designators in the exemplary figures. However, the features in different implementations may differ in other respects and shall not be narrowly confined to what is illustrated in the figures.

The disclosure uses the phrases “in one implementation,” or “in some implementations,” which may refer to one or more of the same or different implementations. The term “coupled” is defined as connected, whether directly or indirectly through intervening components, and is not necessarily limited to physical connections. The term “comprising” means “including, but not necessarily limited to” and specifically indicates open-ended inclusion or membership in the so-described combination, group, series, and the equivalent.

For purposes of explanation and non-limitation, specific details, such as functional entities, techniques, protocols, and standards, are set forth for providing an understanding of the disclosed technology. Detailed disclosure of well-known methods, technologies, systems, and architectures are omitted so as not to obscure the present disclosure with unnecessary details.

Persons skilled in the art will recognize that any disclosed coding function(s) or algorithm(s) described in the present disclosure may be implemented by hardware, software, or a combination of software and hardware. Disclosed functions may correspond to modules that are software, hardware, firmware, or any combination thereof.

A software implementation may include a program having one or more computer-executable instructions stored on a computer-readable medium, such as memory or other types of storage devices. For example, one or more microprocessors or general-purpose computers with communication processing capability may be programmed with computer-executable instructions and perform the disclosed function(s) or algorithm(s).

The microprocessors or general-purpose computers may be formed of application-specific integrated circuits (ASICs), programmable logic arrays, and/or one or more digital signal processors (DSPs). Although some of the disclosed implementations are oriented to software installed and executing on computer hardware, alternative implementations implemented as firmware, as hardware, or as a combination of hardware and software are well within the scope of the present disclosure. The computer-readable medium includes, but is not limited to, random-access memory (RAM), read-only memory (ROM), erasable programmable read-only memory (EPROM), electrically erasable programmable read-only memory (EEPROM), flash memory, compact disc read-only memory (CD ROM), magnetic cassettes, magnetic tape, magnetic disk storage, or any other equivalent medium capable of storing computer-executable instructions. The computer-readable medium may be a non-transitory computer-readable medium.

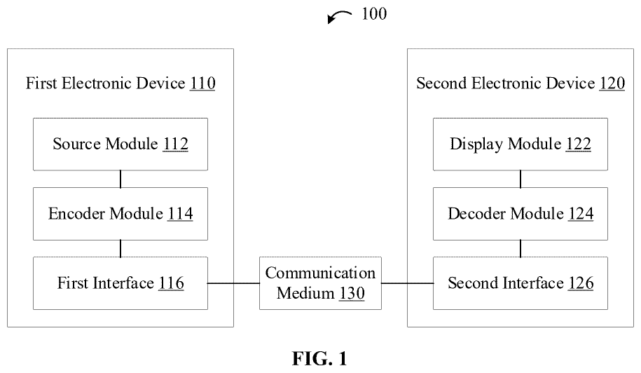

FIG. 1 is a block diagram illustrating a system 100 having a first electronic device and a second electronic device for encoding and decoding video data, in accordance with one or more example implementations of this disclosure.

The system 100 may include a first electronic device 110, a second electronic device 120, and a communication medium 130.

The first electronic device 110 may be a source device including any device configured to encode video data and transmit the encoded video data to the communication medium 130. The second electronic device 120 may be a destination device including any device configured to receive encoded video data via the communication medium 130 and decode the encoded video data.

The first electronic device 110 may communicate via wire, or wirelessly, with the second electronic device 120 via the communication medium 130. The first electronic device 110 may include a source module 112, an encoder module 114, and a first interface 116, among other components. The second electronic device 120 may include a display module 122, a decoder module 124, and a second interface 126, among other components. The first electronic device 110 may be a video encoder and the second electronic device 120 may be a video decoder.

The first electronic device 110 and/or the second electronic device 120 may be a mobile phone, a tablet, a desktop, a notebook, or other electronic devices. FIG. 1 illustrates one example of the first electronic device 110 and the second electronic device 120. The first electronic device 110 and second electronic device 120 may include greater or fewer components than illustrated or have a different configuration of the various illustrated components.

The source module 112 may include a video capture device to capture new video, a video archive to store previously captured video, and/or a video feed interface to receive the video from a video content provider. The source module 112 may generate computer graphics-based data, as the source video, or may generate a combination of live video, archived video, and computer-generated video, as the source video. The video capture device may include a charge-coupled device (CCD) image sensor, a complementary metal-oxide-semiconductor (CMOS) image sensor, or a camera.

The encoder module 114 and the decoder module 124 may each be implemented as any one of a variety of suitable encoder/decoder circuitry, such as one or more microprocessors, a central processing unit (CPU), a graphics processing unit (GPU), a system-on-a-chip (SoC), digital signal processors (DSPs), application-specific integrated circuits (ASICs), field-programmable gate arrays (FPGAs), discrete logic, software, hardware, firmware, or any combinations thereof. When implemented partially in software, a device may store the program having computer-executable instructions for the software in a suitable, non-transitory computer-readable medium and execute the stored computer-executable instructions using one or more processors to perform the disclosed methods. Each of the encoder module 114 and the decoder module 124 may be included in one or more encoders or decoders, any of which may be integrated as part of a combined encoder/decoder (CODEC) in a device.

The first interface 116 and the second interface 126 may utilize customized protocols or follow existing standards or de facto standards including, but not limited to, Ethernet, IEEE 802.11 or IEEE 802.15 series, wireless USB, or telecommunication standards including, but not limited to, Global System for Mobile Communications (GSM), Code-Division Multiple Access 2000 (CDMA2000), Time Division Synchronous Code Division Multiple Access (TD-SCDMA), Worldwide Interoperability for Microwave Access (WiMAX), Third Generation Partnership Project Long-Term Evolution (3GPP-LTE), or Time-Division LTE (TD-LTE). The first interface 116 and the second interface 126 may each include any device configured to transmit a compliant video bitstream via the communication medium 130 and to receive the compliant video bitstream via the communication medium 130.

The first interface 116 and the second interface 126 may include a computer system interface that enables a compliant video bitstream to be stored on a storage device or to be received from the storage device. For example, the first interface 116 and the second interface 126 may include a chipset supporting Peripheral Component Interconnect (PCI) and Peripheral Component Interconnect Express (PCIe) bus protocols, proprietary bus protocols, Universal Serial Bus (USB) protocols, Inter-Integrated Circuit (I2C) protocols, or any other logical and physical structure(s) that may be used to interconnect peer devices.

The display module 122 may include a display using liquid crystal display (LCD) technology, plasma display technology, organic light-emitting diode (OLED) display technology, or light-emitting polymer display (LPD) technology, with other display technologies used in some other implementations. The display module 122 may include a High-Definition display or an Ultra-High-Definition display.

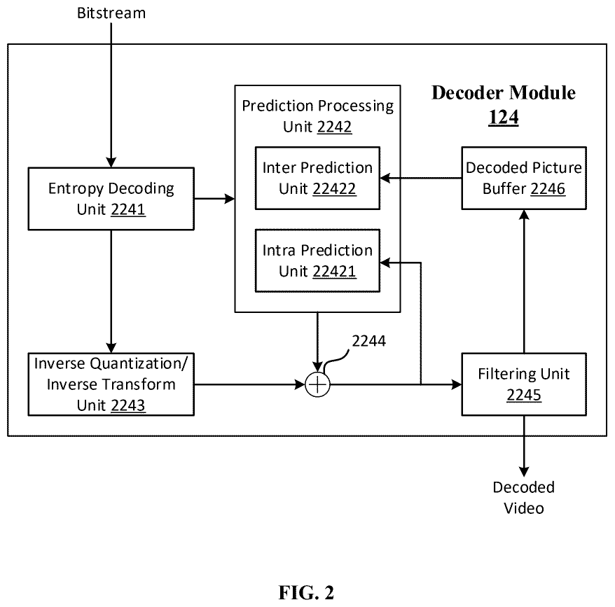

FIG. 2 is a block diagram illustrating a decoder module 124 of the second electronic device 120 illustrated in FIG. 1, in accordance with one or more example implementations of this disclosure. The decoder module 124 may include an entropy decoder (e.g., an entropy decoding unit 2241), a prediction processor (e.g., a prediction processing unit 2242), an inverse quantization/inverse transform processor (e.g., an inverse quantization/inverse transform unit 2243), a summer (e.g., a summer 2244), a filter (e.g., a filtering unit 2245), and a decoded picture buffer (e.g., a decoded picture buffer 2246). The prediction processing unit 2242 further may include an intra prediction processor (e.g., an intra prediction unit 22421) and an inter prediction processor (e.g., an inter prediction unit 22422). The decoder module 124 receives a bitstream, decodes the bitstream, and outputs a decoded video.

The entropy decoding unit 2241 may receive the bitstream including multiple syntax elements from the second interface 126, as shown in FIG. 1, and perform a parsing operation on the bitstream to extract syntax elements from the bitstream. As part of the parsing operation, the entropy decoding unit 2241 may entropy decode the bitstream to generate quantized transform coefficients, quantization parameters, transform data, motion vectors, intra modes, partition information, and/or other syntax information.

The entropy decoding unit 2241 may perform context-adaptive variable length coding (CAVLC), context-adaptive binary arithmetic coding (CABAC), syntax-based context-adaptive binary arithmetic coding (SBAC), probability interval partitioning entropy (PIPE) coding, or another entropy coding technique to generate the quantized transform coefficients. The entropy decoding unit 2241 may provide the quantized transform coefficients, the quantization parameters, and the transform data to the inverse quantization/inverse transform unit 2243 and provide the motion vectors, the intra modes, the partition information, and other syntax information to the prediction processing unit 2242.

The prediction processing unit 2242 may receive syntax elements, such as motion vectors, intra modes, partition information, and other syntax information, from the entropy decoding unit 2241. The prediction processing unit 2242 may receive the syntax elements including the partition information and divide image frames according to the partition information.

Each of the image frames may be divided into at least one image block according to the partition information. The at least one image block may include a luminance block for reconstructing multiple luminance samples and at least one chrominance block for reconstructing multiple chrominance samples. The luminance block and the at least one chrominance block may be further divided to generate macroblocks, coding tree units (CTUs), coding blocks (CBs), sub-divisions thereof, and/or other equivalent coding units.

During the decoding process, the prediction processing unit 2242 may receive predicted data including the intra mode or the motion vector for a current image block of a specific one of the image frames. The current image block may be the luminance block or one of the chrominance blocks in the specific image frame.

The intra prediction unit 22421 may perform intra-predictive coding of a current block unit relative to one or more neighboring blocks in the same frame, as the current block unit, based on syntax elements related to the intra mode in order to generate a predicted block. The intra mode may specify the location of reference samples selected from the neighboring blocks within the current frame. The intra prediction unit 22421 may reconstruct multiple chroma components of the current block unit based on multiple luma components of the current block unit when the multiple chroma components is reconstructed by the prediction processing unit 2242.

The intra prediction unit 22421 may reconstruct multiple chroma components of the current block unit based on the multiple luma components of the current block unit when the multiple luma components of the current block unit is reconstructed by the prediction processing unit 2242.

The inter prediction unit 22422 may perform inter-predictive coding of the current block unit relative to one or more blocks in one or more reference image blocks based on syntax elements related to the motion vector in order to generate the predicted block. The motion vector may indicate a displacement of the current block unit within the current image block relative to a reference block unit within the reference image block. The reference block unit may be a block determined to closely match the current block unit. The inter prediction unit 22422 may receive the reference image block stored in the decoded picture buffer 2246 and reconstruct the current block unit based on the received reference image blocks.

The inverse quantization/inverse transform unit 2243 may apply inverse quantization and inverse transformation to reconstruct the residual block in the pixel domain. The inverse quantization/inverse transform unit 2243 may apply inverse quantization to the residual quantized transform coefficient to generate a residual transform coefficient and then apply inverse transformation to the residual transform coefficient to generate the residual block in the pixel domain.

The inverse transformation may be inversely applied by the transformation process, such as a discrete cosine transform (DCT), a discrete sine transform (DST), an adaptive multiple transform (AMT), a mode-dependent non-separable secondary transform (MDNSST), a Hypercube-Givens transform (HyGT), a signal-dependent transform, a Karhunen-Loéve transform (KLT), a wavelet transform, an integer transform, a sub-band transform, or a conceptually similar transform. The inverse transformation may convert the residual information from a transform domain, such as a frequency domain, back to the pixel domain, etc. The degree of inverse quantization may be modified by adjusting a quantization parameter.

The summer 2244 may add the reconstructed residual block to the predicted block provided by the prediction processing unit 2242 to produce a reconstructed block.

The filtering unit 2245 may include a deblocking filter, a sample adaptive offset (SAO) filter, a bilateral filter, and/or an adaptive loop filter (ALF) to remove the blocking artifacts from the reconstructed block. Additional filters (in loop or post loop) may also be used in addition to the deblocking filter, the SAO filter, the bilateral filter, and the ALF. Such filters (are not explicitly illustrated for brevity of the description) may filter the output of the summer 2244. The filtering unit 2245 may output the decoded video to the display module 122 or other video receiving units after the filtering unit 2245 performs the filtering process for the reconstructed blocks of the specific image frame.

The decoded picture buffer 2246 may be a reference picture memory that stores the reference block to be used by the prediction processing unit 2242 in decoding the bitstream (e.g., in inter-coding modes). The decoded picture buffer 2246 may be formed by any one of a variety of memory devices, such as a dynamic random-access memory (DRAM), including synchronous DRAM (SDRAM), magneto-resistive RAM (MRAM), resistive RAM (RRAM), or other types of memory devices. The decoded picture buffer 2246 may be on-chip along with other components of the decoder module 124 or may be off-chip relative to those components.

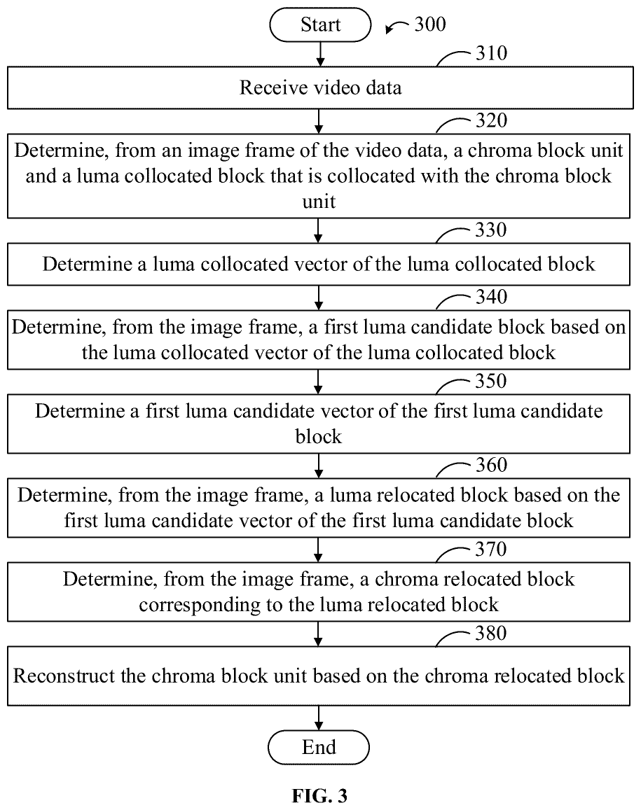

FIG. 3 is a flowchart illustrating a method/process 300 for decoding and/or encoding video data by an electronic device, in accordance with one or more example implementations of this disclosure. The method/process 300 is an example implementation, as there may be a variety of mechanisms of decoding the video data.

The method/process 300 may be performed by an electronic device using the configurations illustrated in FIGS. 1 and/or 2, where various elements of these figures may be referenced to describe the method/process 300. Each block illustrated in FIG. 3 may represent one or more processes, methods, or subroutines performed by an electronic device.

The order in which the blocks appear in FIG. 3 is for illustration only, and may not be construed to limit the scope of the present disclosure, thus the order may be different from what is illustrated. Additional blocks may be added or fewer blocks may be utilized without departing from the scope of the present disclosure.

At block 310, the method/process 300 may start by receiving (e.g., via the decoder module 124, as shown in FIG. 2) the video data. The video data received by the decoder module 124 may include a bitstream.

With reference to FIGS. 1 and 2, the second electronic device 120 may receive the bitstream from an encoder, such as the first electronic device 110 (or other video providers), via the second interface 126.

At block 320, the decoder module 124 may determine, from an image frame of the video data, a chroma block unit and a luma collocated block that is collocated with the chroma block unit.

With reference to FIGS. 1 and 2, the decoder module 124 may determine the image frames included in the bitstream when the video data, received by the decoder module 124, includes the bitstream. The current frame may be one of the image frames, determined according to the bitstream. The decoder module 124 may further divide the current frame to determine the block unit, according to the partition indications in the bitstream. In some implementations, the decoder module 124 may divide the current frame to generate multiple CTUs, and may further divide a current CTU, included in the CTUs, to generate multiple divided blocks and to determine the block unit from the divided blocks, according to the partition indications (e.g., based on any video coding standard).

In some other implementations, the decoder module 124 may divide the current frame to generate multiple slices or multiple tiles, and further divide a current slice or a current tile, included in the slices or the tiles, to generate multiple CTUs. In addition, the decoder module 124 may further divide a current CTU, included in the CTUs, to generate multiple divided blocks and to determine the block unit from the divided blocks, according to the partition indications. The size of the block unit may be Wb×Hb. In some implementations, each of the Wb and Hb may be a positive integer (e.g., 4, 8, etc.) that may be the same, or different from each other.

In some implementations, only one luma block unit may be collocated with the chroma block unit and regarded as a luma collocated block when the chroma block unit is included in a single-tree block unit that is determined from the current frame. In some other implementations, at least one luma block unit may be covered by the luma collocated block that is collocated with the chroma block unit when the chroma block unit is included in a dual-tree block unit. The dual-tree block may be determined from the current frame. Since the luma collocated block may be reconstructed prior to the reconstruction of the chroma block unit, the luma block vector may be determined for predicting and reconstructing the luma collocated block of the block unit prior to the reconstruction of the chroma block unit.

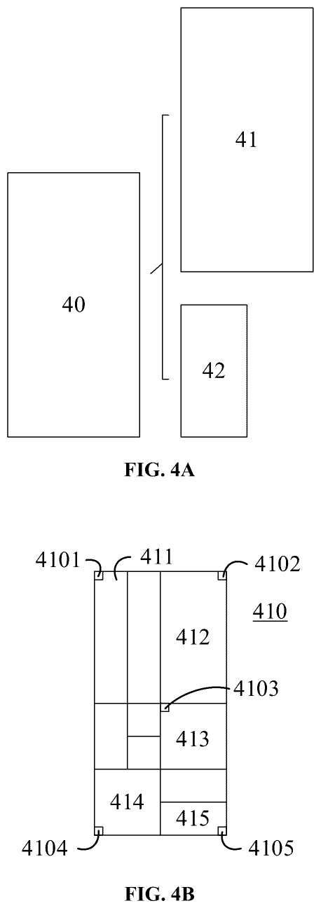

FIGS. 4A and 4B are schematic illustrations of a block unit 40 including a luma collocated block 41 and a chroma block unit 42, in accordance with one or more example implementations of this disclosure. FIG. 4A illustrates the chroma block unit 42 and the luma collocated block 41 that is collocated with the chroma block unit 42. The luma collocated block 41 and the chroma block unit 42 may be included in a block unit 40 (e.g., in a single tree block unit). Since the luma collocated block 41 may be reconstructed prior to the reconstruction of the chroma block unit 42, prediction information of the luma collocated block 41 may be determined, for predicting and reconstructing the luma collocated block 41 of the block unit 40, prior to the reconstruction of the chroma block unit 42. Thus, the chroma block unit 42 may be allowed to be predicted and/or reconstructed based on the prediction information of the block unit 40.

As shown in FIG. 4A, the block unit 40 may include one luma block unit (e.g., the luma collocated block 41), and one chroma block unit 42. The size of the luma collocated block 41 may be identical to the size of the block unit 40. Thus, the size of the luma collocated block 41 may also be Wb×Hb. The size of the chroma block unit 42 may be identical to, or proportional to, the size of the luma collocated block 41.

The size of the chroma block unit 42 may be determined based on a scaling factor. The scaling factor may be determined based on a video format. In some implementations, if the video format is YUV422, the scaling factor may further include a width scaling factor equal to 2 and a height scaling factor equal to 1. Thus, the width of the luma block unit may be double the width of the chroma block unit 42, and the height of the luma block unit may be equal to the height of the chroma block unit 42. In some other implementations, if the video format is YUV420, the scaling factor may further include the width scaling factor and the height scaling factor both equal to 2. Thus, as shown in FIG. 4A, the width of the luma block unit may be double the width of the chroma block unit 42, and the height of the luma block unit may also be double the height of the chroma block unit 42.

FIG. 4B illustrates multiple luma block units, covered by a luma collocated block 410, which is collocated with the chroma block unit 42, as illustrated in FIG. 4A. In some implementations, as shown in FIG. 4B, there may be multiple luma block units in the luma collocated block 410. In some other implementations, the luma collocated block 41 may be unnecessary to be aligned with multiple luma block units that are determined based on the partition indications. For example, the luma collocated block 41 may cover at least one of an entirety of a luma block unit or a portion of another block unit. In other words, multiple boundaries of the luma collocated block 41 may not be aligned with partition lines of the luma block units.

Referring back to FIG. 3, at block 330, the decoder module 124 may determine a luma collocated vector of the luma collocated block.

With reference to FIGS. 1 and 2, the decoder module 124 may check whether the luma collocated block covers one or more luma block units. As shown in FIG. 4A, in some implementations, one luma block unit, included in the block unit 40, may be set as the luma collocated block 41, that is collocated with the chroma block unit 42, when the chroma block unit is included in the single-tree block unit. When the luma collocated block 41 is reconstructed in a block-vector-based mode, the luma collocated block 41 may be reconstructed based on a first luma reconstructed vector. Thus, the first luma reconstructed vector of the luma collocated block 41 may be set as the luma collocated vector of the luma collocated block. In some implementations, the block-vector-based mode may include an intra block copy (IBC) mode and an intra template matching prediction (IntraTMP) mode.

As shown in FIG. 4B, in some implementations, the luma collocated block 410, that is collocated with the chroma block unit 42, may cover multiple luma block units when the chroma block unit is included in the dual-tree block unit. In order to predict the chroma block unit 42, the decoder module 124 may determine a part of the prediction information of the luma block units for predicting the chroma block unit 42.

In some implementations, the decoder module 124 may determine multiple first candidate positions, and select multiple first luma coded blocks from the luma block units based on the first candidate positions. In some implementations, the number of the first candidate positions may be a positive integer (e.g., 3, 4, 5, etc.). In some implementations, as shown in FIG. 4B, the first candidate positions may include at least one of a top-left position 4101, a top-right position 4102, a center position 4103, a bottom-left position 4104, or a bottom-right position 4105 of the luma collocated block 410. It should be noted that the first candidate positions in the luma collocated block 410 may be changed without departing from the scope of the present disclosure.

Each of the selected first luma coded blocks may include at least one of multiple candidate samples. The candidate samples may be located, respectively, at one of the first candidate positions. In some implementations, as shown in FIG. 4B, the first luma coded block 411 may include the candidate sample, that is located at the top-left position 4101, and the first luma coded block 412 may include the candidate sample, that is located at the top-right position 4102. In addition, the first luma coded block 413 may include the candidate sample, that is located at the center position 4103. The first luma coded block 414 may include the candidate sample, that is located at the bottom-left position 4104. And the first luma coded block 415 may include the candidate sample, that is located at the bottom-right position 4105. In some other implementations, one of the first luma coded blocks may include more than one of the candidate samples located, respectively, at more than one of the first candidate positions 4101-4105.

The decoder module 124 may reconstruct the luma block units, that are covered by the luma collocated block 410, using multiple luma prediction schemes. The luma prediction schemes of the luma block units may be identical to, or different from, each other. For examples, the luma prediction scheme of the first luma coded block 411 may be different from the luma prediction schemes of the other luma block units in the luma collocated block 410, or may be identical to at least one of the other luma block units in the luma collocated block 410.

When at least one of the first luma coded blocks, covered by the luma collocated block 410, is reconstructed in the block-vector-based mode, each of the at least one first luma coded block, reconstructed in the block-vector-based mode, may be reconstructed, respectively, based on a first luma reconstructed vector. When the number of the at least one first luma coded block, reconstructed in the block-vector-based mode, is equal to one, the number of the at least one first luma reconstructed vector may be equal to one (e.g., for a uni-predictive block-vector-based mode) or two (e.g., for a bi-predictive block-vector-based mode or a geometric prediction mode). In some implementations, each of the at least one first luma reconstructed vector may be, respectively, set as one of multiple luma collocated vectors of the luma collocated block.

In some other implementations, only one of the first luma reconstructed vectors may be set as the luma collocated vector of the luma collocated block. In some implementations, based on a numerical order of the first candidate positions 4101-4105 (as shown in FIG. 4B), a first determined one of the first luma reconstructed vectors may be set as the luma collocated vector of the luma collocated block. For example, the first luma coded blocks 412 and 413 including, respectively, the top-right position 4102 and the center position 4103, may be reconstructed in the block-vector-based mode. The first luma coded block 411, including the top-left position 4101, however, may not be reconstructed in the block-vector-based mode. Thus, the first luma reconstructed vector of the first luma coded block 412 may be the first determined one of the first luma reconstructed vectors, such that the first luma reconstructed vector of the first luma coded block 412 may be set as the luma collocated vector of the luma collocated block 410. In some other implementations, based on the numerical order of the first candidate positions 4101-4105, a last determined one of the first luma reconstructed vectors may be set as the luma collocated vector of the luma collocated block.

In yet some other implementations, a portion of the first luma reconstructed vectors may be set as the luma collocated vectors of the luma collocated block. In some implementations, based on the numerical order of the first candidate positions 4101-4105, a first determined X number of the first luma reconstructed vectors may be set as the luma collocated vectors of the luma collocated block. In some implementations, the number X may be a positive integer (e.g., 2, 3, 4, etc.). In some implementations, the number of the luma collocated vectors may be an integer (e.g., 0, 1, 2, 3, 4, etc.).

Referring back to FIG. 3, at block 340, the decoder module 124 may determine, from the image frame, a first luma candidate block based on the luma collocated vector of the luma collocated block.

With reference to FIGS. 1 and 2, the decoder module 124 may determine, from the image frame, the first luma candidate block using the luma collocated vector of the luma collocated block. In some implementations, the luma collocated vector of the luma collocated block may indicate the first luma candidate block from the luma collocated block.

In some implementations, the luma collocated vector of the luma collocated block may indicate a top-left position of the first luma candidate block from a first predefined candidate position of the luma collocated block. In some implementations, as shown in FIG. 4B, the first predefined candidate position of the luma collocated block may be the top-left position 4101 or the center position 4103. For example, the luma collocated vector of the luma collocated block may indicate the top-left position of the first luma candidate block from the top-left position 4101 of the luma collocated block.

The image frame may further include a luma frame and a chroma frame. The luma frame may correspond to the chroma frame. Both the first luma candidate block and the luma collocated block may be included in the luma frame of the image frame.

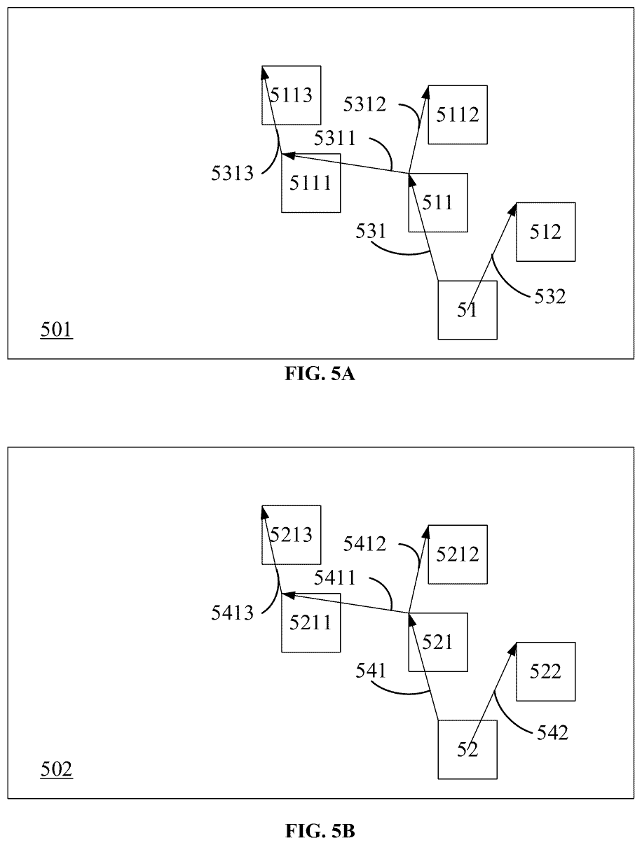

FIGS. 5A and 5B are schematic illustrations of a luma frame 501 and a chroma frame 502, in accordance with one or more example implementations of this disclosure. FIG. 5A illustrates a luma collocated block 51, included in the luma frame 501 of the image frame. The decoder module 124 may determine the luma collocated vectors 531 and 532 of the luma collocated block 51. A first luma candidate block 511, included in the luma frame 501, may be indicated, by the luma collocated vector 531 of the luma collocated block 51, from a top-left position of the luma collocated block 51. In addition, another first luma candidate block 512, included in the luma frame 501, may be indicated, by the luma collocated vector 532 of the luma collocated block 51, from a center position of the luma collocated block 51.

FIG. 5B illustrates a chroma block unit 52, included in the chroma frame 502 of the image frame. A chroma collocated vector 541 may be proportional to the luma collocated vector 531, for example, based on the scaling factor. A chroma collocated vector 542 may also be proportional to the luma collocated vector 532, for example, based on the scaling factor. Thus, a first chroma candidate block 521, included in the chroma frame 502, may be indicated, by the chroma collocated vector 541, from a top-left position of the chroma block unit 52. In addition, another first chroma candidate block 522, included in the chroma frame 502, may be indicated, by the chroma collocated vector 542, from a center position of the chroma block unit 52.

In some implementations, the scaling factor of the image frame, including the luma frame 501 and the chroma frame 502, may be YUV444. Thus, the size of the chroma block unit 52 may be identical to the size of the luma collocated block 51. In some other implementations, the scaling factor of the image frame may be different from the YUV444. Thus, the size of the chroma block unit may be different from the size of the luma collocated block.

Referring back to FIG. 3, at block 350, the decoder module 124 may determine a first luma candidate vector of the first luma candidate block.

With reference to FIGS. 1 and 2, the decoder module 124 may check whether the first luma candidate block covers one or more luma block units. The determination mechanism of the first luma candidate vector at block 350 may be identical to, or similar to, the determination mechanism of the luma collocated vector at block 330. In some implementations, the number of the first luma candidate vectors may be an integer (e.g., 0, 1, 2, 3, 4, 5, etc.).

In some implementations, when the first luma candidate block covers only one luma block unit and the luma block unit is reconstructed in the block-vector-based mode, the luma block unit may be reconstructed based on a second luma reconstructed vector. Thus, the second luma reconstructed vector of the luma block unit may be set as the first luma candidate vector of the first luma candidate block.

In some implementations, the first luma candidate block may cover multiple luma block units. The decoder module 124 may determine multiple second candidate positions of the first luma candidate block. In addition, the decoder module 124 may select multiple second luma coded blocks from the luma block units of the first luma candidate block based on the second candidate positions. The determination mechanism of the first luma candidate vectors, that are determined based on the second luma coded blocks of the first luma candidate block at block 350, may be identical to the determination mechanism of the luma collocated vectors, that are determined based on the first luma coded blocks of the luma collocated block at block 330. For example, the first luma candidate vectors of the first luma candidate block may be determined based on the second candidate positions of the first luma candidate block. The location relationship between the second candidate positions and the first luma candidate block may be identical to the location relationship between the first candidate positions 4101-4105 of and luma collocated block 410, as shown in FIG. 4B.

In some implementations, the first luma candidate block may cover the luma block units. However, when only one of the luma block units, that is located at the second candidate positions of the first luma candidate block, is reconstructed in the block-vector-based mode. The block-vector-reconstructed luma block unit may be reconstructed based on a second luma reconstructed vector. Thus, the second luma reconstructed vector may be set as the first luma candidate vector of the first luma candidate block.

In some other implementations, when at least one of the luma block units, located at the second candidate positions of the first luma candidate block, is reconstructed in the block-vector-based mode, the block-vector-reconstructed luma block units may be reconstructed based on multiple second luma reconstructed vectors. Thus, the second luma reconstructed vectors may be set as multiple first luma candidate vectors of the first luma candidate block.

As shown in FIG. 5A, the decoder module 124 may determine the first luma candidate vectors 5311 and 5312 of the first luma candidate block 511. In addition, there may be no first luma candidate vector of the first luma candidate block 512, determined by the decoder module 124.

Referring back to FIG. 3, at block 360, the decoder module 124 may determine, from the image frame, a luma relocated block based on the first luma candidate vector of the first luma candidate block.

With reference to FIGS. 1 and 2, the decoder module 124 may determine, from the image frame, a second luma candidate block based on the first luma candidate vector of the first luma candidate block. In some implementations, the number of the second luma candidate vectors may be an integer (e.g., 0, 1, 2, 3, 4, 5, etc.).

In some implementations, as shown in FIG. 5A, the first luma candidate vector 5311 of the first luma candidate block 511 may indicate a top-left position of the second luma candidate block 5111 from a second predefined candidate position of the first luma candidate block 511. In some implementations, the second predefined candidate position of the first luma candidate block 511 may be a top-left position or a center position of the first luma candidate block 511. For example, the first luma candidate vector 5311 of the first luma candidate block 511 may indicate the top-left position of the second luma candidate block 5111 from the top-left position of the first luma candidate block 511. In addition, another first luma candidate vector 5312 of the first luma candidate block 511 may indicate a top-left position of another second luma candidate block 5112 from the second predefined candidate position of the first luma candidate block 511.

In some implementations, the second luma candidate block 5111 may be directly regarded as the luma relocated block. In other words, the first luma candidate vector 5311 of the first luma candidate block 511 may be used to directly indicate the luma relocated block from the first luma candidate block 511. In addition, a luma combination vector, formed as a luma relocated vector by the luma collocated vector 531 and the first luma candidate vector 5311, may indicate the luma relocated block from the luma collocated block 51. In some implementations, the second luma candidate block 5112 may be directly regarded as the luma relocated block. Thus, the first luma candidate vector 5312 of the first luma candidate block 511 may also be used to directly indicate the luma relocated block from the first luma candidate block 511. In addition, a luma combination vector, formed as a luma relocated vector by the luma collocated vector 531 and the first luma candidate vector 5312, may indicate the luma relocated block from the luma collocated block 51.

In some other implementations, when the second luma candidate block 5111 is determined, the decoder module 124 may further determine a second luma candidate vector 5313 of the second luma candidate block 5111. The determination mechanism of the second luma candidate vector 5313 at block 360 may be identical to, or similar to, the determination mechanism of the first luma candidate vector 5311 at block 350. In addition, the decoder module 124 may determine, from the image frame, a third luma candidate block 5113 based on the second luma candidate vector 5313 of the second luma candidate block 5111. The third luma candidate block 5113 may then be directly regarded as the luma relocated block. In other words, a luma combination vector, formed as the luma relocated vector by the luma collocated vector 531, the first luma candidate vector 5311, and the second luma candidate vector 5313, may indicate the luma relocated block from the luma collocated block 51. Thus, the decoder module 124 may determine, from the image frame, the luma relocated block further based on the second luma candidate vector 5313 of the second luma candidate block 5111.

In yet some other implementations, when the third luma candidate block 5113 is determined, the decoder module 124 may further determine a third luma candidate vector of the third luma candidate block 5113 for determining a fourth luma candidate block. Moreover, the decoder module 124 may further determine a fourth luma candidate vector of the fourth luma candidate block for determining a fifth luma candidate block. The determination mechanisms of the third and the fourth luma candidate vectors at block 360 may also be identical to, or similar to, the determination mechanism of the first luma candidate vector 5311 at block 350. In some implementations, a relocated level of the luma candidate blocks may be equal to one of the integers from 1 to 5 or a higher positive integer.

Each of the fourth and fifth luma candidate blocks may be regarded as the luma relocated block. The fourth and fifth luma candidate blocks may also be determined based on the second luma candidate vector 5313 of the second luma candidate block 5111, such that the decoder module 124 may determine, from the image frame, the luma relocated block further based on the second luma candidate vector 5313.

Referring back to FIG. 3, at block 370, the decoder module 124 may determine, from the image frame, a chroma relocated block corresponding to the luma relocated block.

With reference to FIGS. 1 and 2, in some implementations, the decoder module 124 may determine, from the chroma frame of the image frame, a chroma collocated block, collocated with the luma relocated block, as the chroma relocated block. Thus, the chroma relocated block may correspond to the luma relocated block.

In some other implementations, the decoder module 124 may determine the luma combination vector, as the luma relocated vector, based on the first luma collocated vector of the luma collocated block and the first luma candidate vector of the first luma candidate block. The decoder module 124 may then determine a chroma relocated vector by scaling the luma relocated vector based on the scaling factor. The chroma relocated vector may be used to directly indicate the chroma relocated block from the chroma block unit. Thus, the chroma relocated block may be determined based on the chroma relocated vector. In some implementations, besides the first luma collocated vector and the first luma candidate vector, the luma combination vector may further include at least one of the second to fourth luma candidate vectors or other additional luma candidate vectors.

As shown in FIGS. 5A and 5B, in some implementations, when the second luma candidate block 5111 is the luma relocated block, the decoder module 124 may directly determine, from the chroma frame 502, a second chroma candidate block 5211, that is collocated with the second luma candidate block 5111, as the chroma relocated block. In some other implementations, when the second luma candidate block 5111 is the luma relocated block, the decoder module 124 may determine the luma combination vector, as the luma relocated vector, based on the first luma collocated vector 531 and the first luma candidate vectors 5311. The decoder module 124 may then determine the chroma relocated vector by scaling the luma relocated vector for determining the chroma relocated block. The chroma relocated vector may be identical to a chroma combination vector, including the chroma collocated vector 541 and a first chroma candidate vectors 5411.

Furthermore, when the second luma candidate block 5112 is the luma relocated block, the decoder module 124 may directly determine, from the chroma frame 502, another second chroma candidate block 5212, that is collocated with the second luma candidate block 5112, as the chroma relocated block. In addition, the second chroma candidate block 5212 may be determined based on the chroma relocated vector, that is generated by scaling the luma combination vector, including the first luma collocated vector 531 and the first luma candidate vector 5312. The chroma relocated vector may be identical to the chroma combination vector, including the chroma collocated vector 541 and a first chroma candidate vector 5412.

In addition, when the third luma candidate block 5113 is the luma relocated block, the decoder module 124 may directly determine, from the chroma frame 502, a third chroma candidate block 5213, that is collocated with the third luma candidate block 5113, as the chroma relocated block. In addition, the third chroma candidate block 5213 may be determined based on the chroma relocated vector, that is generated by scaling the luma combination vector, including the first luma collocated vector 531, the first luma candidate vector 5311, and the second luma candidate vector 5313. The chroma relocated vector may be identical to the chroma combination vector, including the chroma collocated vector 541, the first chroma candidate vector 5411, and a second chroma candidate vector 5413.

Referring back to FIG. 3, at block 380, the decoder module 124 may reconstruct the chroma block unit based on the chroma relocated block.

With reference to FIGS. 1 and 2, in some implementations, the decoder module 124 may determine a chroma candidate list of the chroma block unit for reconstructing the chroma block unit. In some implementations, the chroma candidate list may include multiple chroma prediction candidates, selected from at least one of multiple relocated candidates, or other chroma prediction candidates. In some implementations, the relocated candidates may be selected from at least one of multiple relocated direct block vector (DBV) candidates, or multiple relocated block-vector-guided (BVG) cross-component prediction (CCP) candidates. In some implementations, the relocated DBV candidates may be further included in multiple DBV candidates. In some other implementations, the relocated BVG CCP candidates may be further included in multiple BVG CCP candidates. In yet some other implementations, the chroma prediction candidates may be selected from at least one of the DBV candidates (including the relocated DBV candidates), the BVG CCP candidates (including the relocated BVG CCP candidates), or other chroma prediction candidates.

The decoder module 124 may select a chroma prediction mode from the chroma prediction candidates to reconstruct the chroma block unit. In some implementations, the decoder module 124 may select the chroma prediction mode from the chroma prediction candidates based on a chroma prediction index. In some other implementations, the decoder module 124 may select the chroma prediction mode from the DBV candidates, including at least one of the relocated DBV candidates, based on a DBV index. In yet some other implementations, the decoder module 124 may select the chroma prediction mode from the BVG CCP candidate, including at least one of the relocated BVG CCP candidates, based on a BVG CCP index.

In some implementations, when the chroma prediction mode is selected from the relocated candidates, the decoder module 124 may reconstruct the chroma block unit based on a selected one of the chroma collocated blocks. The selected chroma collocated block may correspond to the selected relocated candidate. Each of the relocated candidates may correspond to one of the chroma relocated blocks and one of the luma relocated blocks.

In some implementations, the decoder module 124 may determine one of the luma relocated blocks based on the relocated candidates, for determining the selected chroma relocated block, to reconstruct the chroma block unit. Thus, the others of the luma relocated blocks, included in, or corresponding to, the others of the relocated candidates, may include multiple unselected luma relocated blocks. In some implementations, in a case that a specific one of the luma relocated blocks is determined based on the chroma prediction candidates to reconstruct the chroma block unit, the selected chroma relocated block may be determined based on the specific luma relocated block.

In some implementations, the decoder module 124 may directly select one of the chroma relocated blocks from the relocated candidates for reconstructing the chroma block unit. Thus, the others of the chroma relocated blocks, included in, or corresponding to, the others of the relocated candidates, may be multiple unselected chroma relocated blocks.

In some implementations, when the chroma prediction mode is selected from the relocated DBV candidates, the decoder module 124 may determine the selected chroma relocated block for reconstructing the chroma block unit. The selected chroma relocated block may be indicated, by a corresponding chroma relocated vector of the chroma block unit, from a third predefined candidate position of the chroma block unit. The decoder module 124 may directly determine the selected chroma relocated block as a chroma predicted block. In some implementations, the third predefined candidate position of the chroma block unit may be a top-left position or a center position of the chroma block unit.

As shown in FIG. 5B, when the third chroma candidate block 5213 is the selected chroma relocated block, the selected chroma relocated vector may be identical to the chroma combination vector, including the chroma collocated vector 541, the first chroma candidate vector 5411, and a second chroma candidate vector 5413 and indicated from the top-left position of the chroma block unit 52.

In some implementations, when the chroma prediction mode is selected from the relocated BVG CCP candidates, the decoder module 124 may determine the selected chroma relocated block for reconstructing the chroma block unit. The selected chroma relocated block, collocated with a corresponding luma relocated block, may be indicated, by the selected chroma relocated vector of the chroma block unit, from the third predefined candidate position of the chroma block unit.

The decoder module 124 may further determine a luma scaled block based on the corresponding luma relocated block. For example, the luma scaled block of the corresponding luma relocated block may be determined based on the scaling factor of the image frame. The size of the luma scaled block may be identical to the size of the chroma relocated block. Thus, the decoder module 124 may derive a cross-component filter based on the luma scaled block and the selected chroma relocated block. The scaling factor for the determination of the luma scaled block may be identical to the scaling factor for the determination of the chroma relocated vector, used for determining the cross-component filter. The decoder module 124 may then predict the chroma block unit using the cross-component filter based on the luma collocated block to generate a chroma predicted block.

In some implementations, after the cross-component filter is derived based on the luma scaled block and the selected chroma relocated block, the decoder module 124 may further determine a scaled luma collocated block of the luma collocated block based on the scaling factor. The decoder module 124 may then predict the chroma block unit using the cross-component filter based on the scaled luma collocated block to generate the chroma predicted block.

As shown in FIG. 5B, when the second chroma candidate block 5212 is the selected chroma relocated block, the selected chroma relocated vector may be identical to the chroma combination vector, including the chroma collocated vector 541, and the second chroma candidate vector 5412 and indicated from the top-left position of the chroma block unit 52. In addition, the cross-component filter of the chroma block unit 52 may be derived based on the second chroma candidate block 5212 and the second luma candidate block 5112, collocated with the second chroma candidate block 5212.

The decoder module 124 may determine multiple chroma residual components of a chroma residual block from the bitstream for the chroma block unit and add the chroma residual components into the chroma predicted block to reconstruct the chroma block unit. The decoder module 124 may reconstruct all of the other chroma block units in the image frame for reconstructing the image frame and the video. The method/process 300 may then end.

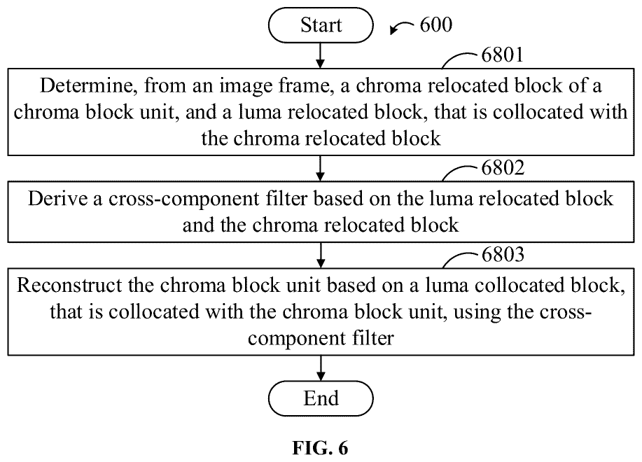

FIG. 6 is a flowchart illustrating a method/process 600 for decoding and/or encoding video data by an electronic device, in accordance with one or more example implementations of this disclosure. The method/process 600 is an example implementation, as there may be a variety of mechanisms of decoding the video data.

The method/process 600 may be performed by an electronic device using the configurations illustrated in FIGS. 1 and/or 2, where various elements of these figures may be referenced to describe the method/process 600. Each block illustrated in FIG. 6 may represent one or more processes, methods, or subroutines performed by an electronic device.

The order in which the blocks appear in FIG. 6 is for illustration only, and may not be construed to limit the scope of the present disclosure, thus the order may be different from what is illustrated. Additional blocks may be added or fewer blocks may be utilized without departing from the scope of the present disclosure. In some implementations, the method/process 600 may be incorporated into the method/process 300, as shown in FIG. 3. In some other implementations, the method/process 300 may be incorporated into the method/process 600.

At block 6801, the method/process 600 may start by determining, from an image frame, a chroma relocated block of a chroma block unit, and a luma relocated block, that is collocated with the chroma relocated block.

With reference to FIGS. 1 and 2, the second electronic device 120 may receive video data from an encoder, such as the first electronic device 110 (or other video providers), via the second interface 126. The video data received by the decoder module 124 may include a bitstream.

The decoder module 124 may determine image frames included in the bitstream. A current frame may be one of the image frames, determined according to the bitstream. The decoder module 124 may further divide the current frame to determine a block unit, according to the partition indications in the bitstream. The current frame may further include a luma frame and a chroma frame. The luma frame may correspond to the chroma frame.

The block unit may include the chroma block unit, that is included in the chroma frame, and a luma collocated block that is included in the luma frame and collocated with the chroma block unit. In some implementations, only one luma block unit may be collocated with the chroma block unit and may be regarded as a luma collocated block when the chroma block unit is included in a single-tree block unit that is determined from the current frame. In some other implementations, at least one luma block unit may be covered by the luma collocated block, that is collocated with the chroma block unit when the chroma block unit is included in a dual-tree block unit, determined from the current frame. Since the luma collocated block may be reconstructed prior to the reconstruction of the chroma block unit, the luma block vector may be determined for predicting and reconstructing the luma collocated block of the block unit prior to the reconstruction of the chroma block unit.

The decoder module 124 may determine, from the luma frame, the luma relocated block of the luma collocated block. In addition, the decoder module 124 may determine, from the chroma frame, the chroma relocated block that is collocated with the luma relocated block. The determination mechanism of the luma relocated block in the method/process 600 may be identical to the determination mechanism described in the method/process 300. In addition, the determination mechanism of the chroma relocated block in the method/process 600 may also be identical to the determination mechanism described in the method/process 300.

At block 6802, the decoder module 124 may derive a cross-component filter based on the luma relocated block and the chroma relocated block.

With reference to FIGS. 1 and 2, in some implementations, the decoder module 124 may determine a luma scaled block based on the luma relocated block. For example, the luma scaled block of the luma relocated block may be determined based on the scaling factor using a down-sampling filter. In addition, the luma scaled block of the luma relocated block may be determined based on the scaling factor using a sub-sampling filter. The size of the luma scaled block may be identical to the size of the chroma relocated block. Thus, the cross-component filter may be derived based on the luma scaled block and the chroma relocated block. The scaling factor for the determination of the luma scaled block may be identical to the scaling factor for the determination of the chroma relocated vector, used for determining the cross-component filter.

In some implementations, the cross-component filter may be generated by deriving multiple filter coefficients of a predefined chroma filter based on the luma scaled block and the chroma relocated block. In some implementations, the cross-component filter may be derived in a block-vector-guided convolutional cross-component model (BVG-CCCM) mode.

In some implementations, the predefined chroma filter may include a quadratic equation. The quadratic equation may include Ns luma spatial sample terms, Np non-linear terms, and one bias term B. The number Ns may be an integer (e.g., 3, 4, 5, etc.). The number Np may also be an integer (e.g., 0, 1, 2, 3, 4, 5, etc.). In some implementations, the quadratic equation, including five luma spatial sample terms, five non-linear terms, and one bias term B, may be used in the BVG-CCCM mode. The five luma spatial sample terms may include a center sample C, a north sample N, a south sample S, a west sample W, and an cast sample E. Thus, the predefined chroma filter may be shown, as in the following equation:

$$predChromaVal = c 0 \times C + c 1 \times N + c 2 \times S + c 3 \times E + c 4 \times W + c 5 \times P ( C ) + c 6 \times P ( N ) + c 7 \times P ( S ) + c 8 \times P ( E ) + c 9 \times P ( W ) + c 10 \times B$$

where the coefficients c0-c10 are eleven filter coefficients for the luma spatial sample terms C, N, S, W, and E, the non-linear terms, and the bias term B, and where predChromaVal may include a predicted chroma sample located at a sample position (x, y), relative to a top-left chroma sample of the chroma block unit 52. The non-linear term P(Q) may be equal to (Q×Q+midVal)>>bitDepth, and the bias term B may be equal to 2^{bitDepth-1}. The parameter midVal and the bias term B may be set as to a middle luma value, and the parameter bitDepth may be a bit depth of the samples in the bitstream. For example, the bias term B may be set as 512 for 10 bits content.

In some implementations, the quadratic equation, including five luma spatial sample terms, one non-linear term, and one bias term B, may be used in the BVG-CCCM mode. The five luma spatial sample terms may include the center sample C, the north sample N, the south sample S, the west sample W, and the east sample E. Thus, the predefined chroma filter may be shown, as in the following equation:

$$predChromaVal = c 0 \times C + c 1 \times N + c 2 \times S + c 3 \times E + c 4 \times W + c 5 \times P ( C ) + c 6 \times B$$

where the coefficients c0-c6 are seven filter coefficients for the luma spatial sample terms C, N, S, W, and E, the non-linear terms, and the bias term B, and where predChromaVal may be a predicted chroma sample located at the sample position (x, y), relative to the top-left chroma sample of the chroma block unit 52.

In some implementations, the predefined chroma filter may be a linear model equation. The linear model equation may include seven spatial sample terms and one bias term B. The seven luma spatial sample terms may include the center sample C, the north sample N, the south sample S, the west sample W, the cast sample E, a first adjacent sample A1, located adjacent to one of the north sample N or the west sample W, and a second adjacent sample A2, located adjacent to one of the south sample S or the cast sample E. Thus, the predefined chroma filter may be shown, as in the following equation:

$$predChromaVal = c 0 \times C + c 1 \times N + c 2 \times S + c 3 \times E + c 4 \times W + c 5 \times A 1 + c 6 \times A 2 + c 7 \times B$$

where the coefficients c0-c7 are eighth filter coefficients for the luma spatial sample terms C, N, S, W, and E, the non-linear terms, and the bias term B, and where predChromaVal may be a predicted chroma sample located at the sample position (x, y), relative to the top-left chroma sample of the chroma block unit 52. It should be noted that the predefined chroma filter may be changed without departing from the scope of the present disclosure.

The decoder module 124 may derive the filter coefficients of the predefined chroma filter based on the luma scaled block and the chroma relocated block. In some implementations, the filter coefficients of the predefined chroma filter may be derived using the LDL decomposition. In some implementations, the filter coefficients of the predefined chroma filter may be derived using the gaussian elimination. In some implementations, the filter coefficients of the predefined chroma filter may be derived by the same method as in the BVG-CCCM of a video coding standard.

Referring back to FIG. 6, at block 6803, the decoder module 124 may reconstruct the chroma block unit based on a luma collocated block, that is collocated with the chroma block unit, using the cross-component filter.

With reference to FIGS. 1 and 2, in some implementations, the decoder module 124 may predict the chroma block unit, using the cross-component filter, based on the luma collocated block to generate a chroma predicted block. The decoder module 124 may further determine a scaled luma collocated block of the luma collocated block based on the scaling factor. The decoder module 124 may then predict the chroma block unit, using the cross-component filter, based on the scaled luma collocated block to generate the chroma predicted block.

The decoder module 124 may determine multiple chroma residual components of a chroma residual block from the bitstream for the chroma block unit and add the chroma residual components to the chroma predicted block to reconstruct the chroma block unit. The decoder module 124 may reconstruct all of the other chroma block units in the image frame for reconstructing the image frame and the video. Referring back to FIG. 3, the method/process 300 may then end.

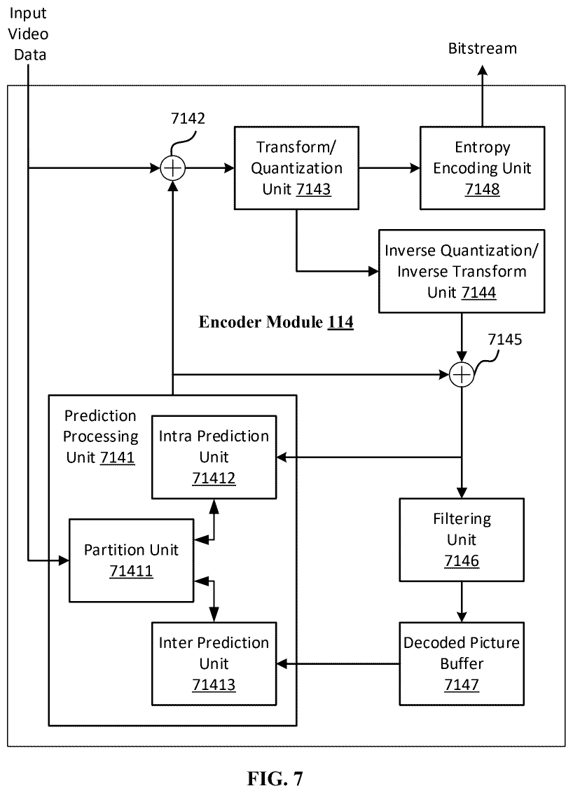

FIG. 7 is a block diagram illustrating an encoder module 114 of the first electronic device 110 illustrated in FIG. 1, in accordance with one or more example implementations of this disclosure. The encoder module 114 may include a prediction processor (e.g., a prediction processing unit 7141), at least a first summer (e.g., a first summer 7142) and a second summer (e.g., a second summer 7145), a transform/quantization processor (e.g., a transform/quantization unit 7143), an inverse quantization/inverse transform processor (e.g., an inverse quantization/inverse transform unit 7144), a filter (e.g., a filtering unit 7146), a decoded picture buffer (e.g., a decoded picture buffer 7147), and an entropy encoder (e.g., an entropy encoding unit 7148). The prediction processing unit 7141 of the encoder module 114 may further include a partition processor (e.g., a partition unit 71411), an intra prediction processor (e.g., an intra prediction unit 71412), and an inter prediction processor (e.g., an inter prediction unit 71413). The encoder module 114 may receive the source video and encode the source video to output a bitstream.

The encoder module 114 may receive source video including multiple image frames and then divide the image frames according to a coding structure. Each of the image frames may be divided into at least one image block.

The at least one image block may include a luminance block having multiple luminance samples and at least one chrominance block having multiple chrominance samples. The luminance block and the at least one chrominance block may be further divided to generate macroblocks, CTUs, CBs, sub-divisions thereof, and/or other equivalent coding units.

The encoder module 114 may perform additional sub-divisions of the source video. It should be noted that the disclosed implementations are generally applicable to video coding regardless of how the source video is partitioned prior to and/or during the encoding.

During the encoding process, the prediction processing unit 7141 may receive a current image block of a specific one of the image frames. The current image block may be the luminance block or one of the chrominance blocks in the specific image frame.

The partition unit 71411 may divide the current image block into multiple block units. The intra prediction unit 71412 may perform intra-predictive coding of a current block unit relative to one or more neighboring blocks in the same frame, as the current block unit, in order to provide spatial prediction. The inter prediction unit 71413 may perform inter-predictive coding of the current block unit relative to one or more blocks in one or more reference image blocks to provide temporal prediction.

The prediction processing unit 7141 may select one of the coding results generated by the intra prediction unit 71412 and the inter prediction unit 71413 based on a mode selection method, such as a cost function. The mode selection method may be a rate-distortion optimization (RDO) process.

The prediction processing unit 7141 may determine the selected coding result and provide a predicted block corresponding to the selected coding result to the first summer 7142 for generating a residual block and to the second summer 7145 for reconstructing the encoded block unit. The prediction processing unit 7141 may further provide syntax elements, such as motion vectors, intra-mode indicators, partition information, and/or other syntax information, to the entropy encoding unit 7148.

The intra prediction unit 71412 may intra-predict the current block unit. The intra prediction unit 71412 may determine an intra prediction mode directed toward a reconstructed sample neighboring the current block unit in order to encode the current block unit.

The intra prediction unit 71412 may encode the current block unit using various intra prediction modes. The intra prediction unit 71412 of the prediction processing unit 7141 may select an appropriate intra prediction mode from the selected modes. The intra prediction unit 71412 may encode the current block unit using a cross-component prediction mode to predict one of the two chroma components of the current block unit based on the luma components of the current block unit. The intra prediction unit 71412 may predict a first one of the two chroma components of the current block unit based on the second of the two chroma components of the current block unit.

The inter prediction unit 71413 may inter-predict the current block unit as an alternative to the intra prediction performed by the intra prediction unit 71412. The inter prediction unit 71413 may perform motion estimation to estimate motion of the current block unit for generating a motion vector.

The motion vector may indicate a displacement of the current block unit within the current image block relative to a reference block unit within a reference image block. The inter prediction unit 71413 may receive at least one reference image block stored in the decoded picture buffer 7147 and estimate the motion based on the received reference image blocks to generate the motion vector.

The first summer 7142 may generate the residual block by subtracting the prediction block determined by the prediction processing unit 7141 from the original current block unit. The first summer 7142 may represent the component or components that perform this subtraction.

The transform/quantization unit 7143 may apply a transform to the residual block in order to generate a residual transform coefficient and then quantize the residual transform coefficients to further reduce the bit rate. The transform may be one of a DCT, DST, AMT, MDNSST, HyGT, signal-dependent transform, KLT, wavelet transform, integer transform, sub-band transform, and a conceptually similar transform.

The transform may convert the residual information from a pixel value domain to a transform domain, such as a frequency domain. The degree of quantization may be modified by adjusting a quantization parameter.

The transform/quantization unit 7143 may perform a scan of the matrix including the quantized transform coefficients. Alternatively, the entropy encoding unit 7148 may perform the scan.

The entropy encoding unit 7148 may receive multiple syntax elements from the prediction processing unit 7141 and the transform/quantization unit 7143, including a quantization parameter, transform data, motion vectors, intra modes, partition information, and/or other syntax information. The entropy encoding unit 7148 may encode the syntax elements into the bitstream.

The entropy encoding unit 7148 may entropy encode the quantized transform coefficients by performing CAVLC, CABAC, SBAC, PIPE coding, or another entropy coding technique to generate an encoded bitstream. The encoded bitstream may be transmitted to another device (e.g., the second electronic device 120, as shown in FIG. 1) or archived for later transmission or retrieval.

The inverse quantization/inverse transform unit 7144 may apply inverse quantization and inverse transformation to reconstruct the residual block in the pixel domain for later use as a reference block. The second summer 7145 may add the reconstructed residual block to the prediction block provided by the prediction processing unit 7141 in order to produce a reconstructed block for storage in the decoded picture buffer 7147.

The filtering unit 7146 may include a deblocking filter, an SAO filter, a bilateral filter, and/or an ALF to remove blocking artifacts from the reconstructed block. Other filters (in loop or post loop) may be used in addition to the deblocking filter, the SAO filter, the bilateral filter, and the ALF. Such filters are not illustrated for brevity and may filter the output of the second summer 7145.

The decoded picture buffer 7147 may be a reference picture memory that stores the reference block to be used by the encoder module 714 to encode video, such as in intra-coding or inter-coding modes. The decoded picture buffer 7147 may include a variety of memory devices, such as DRAM (e.g., including SDRAM), MRAM, RRAM, or other types of memory devices. The decoded picture buffer 7147 may be on-chip with other components of the encoder module 114 or off-chip relative to those components.

The method/process 300 for decoding and/or encoding video data may be performed by the first electronic device 110. With reference to FIGS. 1 and 7, at block 310, the method/process 300 may start by the encoder module 114 receiving the video data. The video data received by the encoder module 114 may be a video.

At block 320, the encoder module 114 may determine, from an image frame of the video data, a chroma block unit and a luma collocated block that is collocated with the chroma block unit.

With reference to FIGS. 1 and 7, the encoder module 114 may divide the image frame to generate multiple CTUs, and further divide a current CTU included in the CTUs to generate multiple divided blocks and to determine the block unit from the divided blocks, according to the partition indications (e.g., based on any video coding standard).

In some implementations, only one luma block unit may be collocated with the chroma block unit and regarded as a luma collocated block when the chroma block unit is included in a single-tree block unit, determined from the current frame. In some other implementations, at least one luma block unit may be covered by the luma collocated block, collocated with the chroma block unit when the chroma block unit is included in a dual-tree block unit, determined from the current frame. Since the luma collocated block may be reconstructed prior to the prediction of the chroma block unit, the luma block vector may be determined for predicting and reconstructing the luma collocated block of the block unit prior to the prediction of the chroma block unit.

In some implementations, as shown in FIG. 4A, the size of the luma collocated block 41 may be identical to the size of the block unit 40. The size of the chroma block unit 42 may be determined based on a scaling factor. The scaling factor may be determined based on a video format.

In some implementations, as shown in FIG. 4B, there may be multiple luma block units in the luma collocated block 410. In some implementations, the luma collocated block 41 may be unnecessary to be aligned with multiple luma block units determined based on the partition indications. For example, the luma collocated block 41 may cover at least one of an entirety of a luma block unit or a portion of another block unit. In other words, multiple boundaries of the luma collocated block 41 may not be aligned with partition lines of the luma block units.

At block 330, the encoder module 114 may determine a luma collocated vector of the luma collocated block. With reference to FIGS. 1 and 7, the luma collocated vector of the luma collocated block, determined by the encoder module 114, may be identical to that determined by the decoder module 124.

The encoder module 114 may check whether the luma collocated block covers one or more luma block units. As shown in FIG. 4A, in some implementations, one luma block unit, included in the block unit 40, may be set as the luma collocated block 41, collocated with the chroma block unit 42. When the luma collocated block 41 is reconstructed in a block-vector-based mode, a first luma reconstructed vector, used to reconstruct the luma collocated block 41, may be set as the luma collocated vector of the luma collocated block. In some implementations, the block-vector-based mode may include an IBC mode and an IntraTMP mode.

As shown in FIG. 4B, in some implementations, the luma collocated block 410, collocated with the chroma block unit 42, may cover multiple luma block units. In some implementations, the encoder module 114 may select multiple first luma coded blocks from the luma block units based on multiple first candidate position, such as at least one of a top-left position 4101, a top-right position 4102, a center position 4103, a bottom-left position 4104, or a bottom-right position 4105 of the luma collocated block 410.

When at least one of the first luma coded blocks, covered by the luma collocated block 410, is reconstructed in the block-vector-based mode, the at least one first luma coded block, reconstructed in the block-vector-based mode, may be reconstructed, respectively, based on a first luma reconstructed vector. In some implementations, each of the at least one first luma reconstructed vector may be, respectively, set as one of multiple luma collocated vectors of the luma collocated block.

In some other implementations, based on a numerical order of the first candidate positions 4101-4105, a first determined X or a last determined X of the first luma reconstructed vectors may be set as the luma collocated vectors of the luma collocated block. In some implementations, the number X may be an integer (e.g., 1, 2, 3, 4, etc.). In some implementations, the number of the luma collocated vectors may be an integer (e.g., 0, 1, 2, 3, 4, etc.).

Referring back to FIG. 3, at block 340, the encoder module 114 may determine, from the image frame, a first luma candidate block based on the luma collocated vector of the luma collocated block. With reference to FIGS. 1 and 7, the first luma candidate block, determined by the encoder module 114, may be identical to that determined by the decoder module 124.

The encoder module 114 may determine, from the image frame, the first luma candidate block using the luma collocated vector of the luma collocated block. In some implementations, the luma collocated vector of the luma collocated block may indicate the first luma candidate block from a first predefined candidate position of the luma collocated block. In some implementations, as shown in FIG. 4B, the first predefined candidate position of the luma collocated block may be the top-left position 4101 or the center position 4103.

As shown in FIG. 5A, the image frame may further include a luma frame 501 and a chroma frame 502. The luma frame may correspond to the chroma frame. The encoder module 114 may determine the luma collocated vectors 531 and 532 of the luma collocated block 51, indicating first luma candidate blocks 511 and 512, included in the luma frame 501.

With reference to FIGS. 5A and 5B, a chroma collocated vector 541 may be proportional to the luma collocated vector 531 based on the scaling factor, and a chroma collocated vector 542 may also be proportional to the luma collocated vector 532 based on the scaling factor.

Referring back to FIG. 3, at block 350, the encoder module 114 may determine a first luma candidate vector of the first luma candidate block. With reference to FIGS. 1 and 7, the first luma candidate vector of the first luma candidate block, determined by the encoder module 114, may be identical to that determined by the decoder module 124.

The encoder module 114 may check whether the first luma candidate block covers one or more luma block units. In some implementations, when the first luma candidate block covers only one luma block unit and the luma block unit is reconstructed in the block-vector-based mode, a second luma reconstructed vector of the first luma candidate block may be set as the first luma candidate vector of the first luma candidate block.

In some implementations, the first luma candidate block may cover multiple luma block units. The encoder module 114 may select multiple second luma coded blocks from the luma block units of the first luma candidate block based on multiple second candidate positions, which similar to the first candidate positions. When at least one of the second luma coded blocks, covered by the first luma candidate block, is reconstructed in the block-vector-based mode, the at least one first luma coded block, reconstructed in the block-vector-based mode, may be reconstructed, respectively, based on a second luma reconstructed vector. In some implementations, each of the at least one second luma reconstructed vector may be, respectively, set as one of multiple first luma candidate vectors of the first luma candidate block.

Referring back to FIG. 3, at block 360, the encoder module 114 may determine, from the image frame, a luma relocated block based on the first luma candidate vector of the first luma candidate block. With reference to FIGS. 1 and 7, the luma relocated block, determined by the encoder module 114, may be identical to that determined by the decoder module 124.

The encoder module 114 may determine, from the image frame, a second luma candidate block based on the first luma candidate vector of the first luma candidate block. In some implementations, the second luma candidate block may be directly regarded as the luma relocated block. In other words, the first luma candidate vector of the first luma candidate block may be used to directly indicate the luma relocated block from the first luma candidate block. I

In some other implementations, the encoder module 114 may further determine a second luma candidate vector of the second luma candidate block. In addition, the encoder module 114 may determine, from the image frame, a third luma candidate block based on the second luma candidate vector of the second luma candidate block.

In yet some other implementations, the encoder module 114 may further determine a third luma candidate vector of the third luma candidate block for determining a fourth luma candidate block. Moreover, the encoder module 114 may further determine a fourth luma candidate vector of the fourth luma candidate block for determining a fifth luma candidate block. The determination mechanisms of the second to the fourth luma candidate vectors at block 360 may also be identical to, or similar to, the determination mechanism of the first luma candidate vector at block 350. Each of the third to the fifth luma candidate blocks may also be allowable to be regarded as the luma relocated block. In some implementations, a relocated level of the luma candidate blocks may be equal to one of the integers from 1 to 5 or a higher positive integer.

Referring back to FIG. 3, at block 370, the encoder module 114 may determine, from the image frame, a chroma relocated block corresponding to the luma relocated block. With reference to FIGS. 1 and 7, the chroma relocated block, determined by the encoder module 114, may be identical to that determined by the decoder module 124.

In some implementations, the encoder module 114 may determine, from the chroma frame of the image frame, a chroma collocated block, collocated with the luma relocated block, as the chroma relocated block. Thus, the chroma relocated block may correspond to the luma relocated block.

In some other implementations, the encoder module 114 may determine a luma combination vector, as the luma relocated vector, based on the first luma collocated vector and the first luma candidate vector. The encoder module 114 may then determine a chroma relocated vector by scaling the luma relocated vector based on the scaling factor. The chroma relocated vector may be used to directly indicate the chroma relocated block from the chroma block unit. Thus, the chroma relocated block may be determined based on the chroma relocated vector. In some implementations, besides the first luma collocated vector and the first luma candidate vector, the luma combination vector may further include at least one of the second to the fourth luma candidate vectors or other additional luma candidate vectors.

Referring back to FIG. 3, at block 380, the encoder module 114 may reconstruct the chroma block unit based on the chroma relocated block.

With reference to FIGS. 1 and 7, in some implementations, the encoder module 114 may determine a chroma candidate list of the chroma block unit for predicting the chroma block unit. In some implementations, the chroma candidate list may include multiple chroma prediction candidates, selected from at least one of multiple relocated candidates, or other chroma prediction candidate. In some implementations, the relocated candidates may be selected from at least one of multiple relocated direct block vector (DBV) candidates, or multiple relocated block-vector-guided (BVG) cross-component prediction (CCP) candidates In some implementations, the relocated DBV candidates may be further included in multiple DBV candidates. In some other implementations, the relocated BVG CCP candidates may be further included in multiple BVG CCP candidates. In yet some other implementations, the chroma prediction candidates may be selected from at least one of the DBV candidates including the relocated DBV candidates, the BVG CCP candidates including the relocated BVG CCP candidates, or other chroma prediction candidates.

The encoder module 114 may predict the chroma block unit based on each of the chroma prediction candidates, including the relocated candidates, to generate multiple chroma predicted blocks. The encoder module 114 may select one of the chroma predicted blocks based on a mode selection method, such as a cost function. The mode selection method may be an RDO process, a Sum of Absolute Difference (SAD) process, a Sum of Absolute Transformed Difference (SATD) process, a Mean Absolute Difference (MAD) process, a Mean Squared Difference (MSD) process, or a Structural SIMilarity (SSIM) process. The encoder module 114 may provide the selected coding result to the first summer 8142 for generating a chroma residual block and to the second summer 8145 for reconstructing the encoded chroma block unit.

The encoder module 114 may further provide syntax elements, included in the bitstream, for transmitting to the decoder module 124. The syntax elements of the chroma block unit may be used to determine a selected chroma prediction candidate corresponding to the selected chroma predicted block. The syntax elements may include one of a chroma prediction index, a DBV index, or a BVG CCP index.

In some implementations, the encoder module 114 may provide the chroma prediction index when the decoder module 124 selects the chroma prediction mode from the chroma prediction candidates. In some other implementations, the encoder module 114 may provide the DBV index when the encoder module 114 provides other syntax elements to indicate the decoder module 124 to select the chroma prediction mode from the DBV candidates. In yet some other implementations, the encoder module 114 may provide the BVG CCP index when the encoder module 114 provides other syntax elements to indicate the decoder module 124 to select the chroma prediction mode from the BVG CCP candidates.

In some other implementations, when the selected chroma prediction candidate corresponds to a predefined one of the relocated candidates, the syntax elements, for determining the selected chroma prediction candidate, may be excluded from the bitstream. Thus, the decoder module 124 may directly determine the predefine chroma prediction candidate as the chroma prediction mode without receiving the corresponding syntax element from the bitstream. In some implementations, the predefined relocated candidate may be one of a predefined one of the relocated DBV candidates or a predefined one of the relocated BVG CCP candidates. For example, the predefined relocated candidate may be one of a first determined one of the relocated DBV candidates or a first determined one of the relocated BVG CCP candidates.

When a specific one of the relocated candidates is selected, the encoder module 114 may predict the chroma block unit based on a selected chroma relocated block, corresponding to the specific relocated candidate, to generate a chroma predicted block. The encoder module 114 may determine multiple chroma residual components of a chroma residual block for the chroma block unit based on the chroma predicted block. In addition, the encoder module 114 may add the chroma residual components back into the chroma predicted block to reconstruct the chroma block unit.

The reconstruction of the chroma block unit by the encoder module 114 may be identical to the reconstruction of the chroma block unit by the decoder module 124. The method/process 300 for the encoder module 114 may then end.

The method/process 600 for decoding and/or encoding video data may be performed by the first electronic device 110. In some implementations, the method/process 600 may be incorporated into the method/process 300, as shown in FIG. 3. In some other implementations, the method/process 300 may be incorporated into the method/process 600.

At block 6801, the method/process 600 may start by determining, from an image frame, a chroma relocated block of a chroma block unit, and a luma relocated block, collocated with the chroma relocated block. The determination of the luma relocated block in the method/process 600 may be identical to that in the method/process 300. In addition, the determination of the chroma relocated block in the method/process 600 may also be identical to that in the method/process 300. In other words, with reference to FIGS. 1 and 7, the luma relocated block and the chroma relocated block, determined by the encoder module 114, may be identical to those determined by the decoder module 124.

At block 6802, the encoder module 114 may derive a cross-component filter based on the luma relocated block and the chroma relocated block. With reference to FIGS. 1 and 7, the cross-component filter, determined by the encoder module 114, may be identical to those determined by the decoder module 124.

With reference to FIGS. 1 and 7, in some implementations, the encoder module 114 may determine a luma scaled block based on the luma relocated block. For example, the luma scaled block may be determined based on the scaling factor using a down-sampling filter or a sub-sampling filter. The size of the luma scaled block may be identical to the size of the chroma relocated block. Thus, the cross-component filter may be derived based on the luma scaled block and the chroma relocated block.

In some implementations, the cross-component filter may be generated by deriving multiple filter coefficients of a predefined chroma filter based on the luma scaled block and the chroma relocated block. In some implementations, the cross-component filter may be derived in block-vector-guided convolutional cross-component model (BVG-CCCM) mode.

In some implementations, the predefined chroma filter may be a quadratic equation. In some implementations, the quadratic equation, including five luma spatial sample terms, five non-linear terms and one bias term B, may be used in the BVG-CCCM mode.

The encoder module 114 may derive the filter coefficients of the predefined chroma filter based on the luma scaled block and the chroma relocated block. In some implementations, the filter coefficients may be derived using the one of LDL decomposition and the gaussian elimination. In some implementations, the filter coefficients may be derived by the same method in BVG-CCCM of a video coding standard.

Referring back to FIG. 6, at block 6803, the encoder module 114 may reconstruct the chroma block unit based on a luma collocated block, collocated with the chroma block unit, using the cross-component filter.

With reference to FIGS. 1 and 7, in some implementations, the encoder module 114 may determine a chroma candidate list of the chroma block unit for predicting the chroma block unit. In some implementations, the chroma candidate list may include multiple chroma prediction candidates, selected from at least one of multiple relocated candidates, or other chroma prediction candidates. In some implementations, the relocated candidates may be selected from at least one of multiple relocated BVG CCP candidates, or other relocated candidate lists. In some implementations, the chroma prediction candidates may be selected from at least one of the BVG CCP candidates including the relocated BVG CCP candidates, or other chroma prediction candidates.

The encoder module 114 may predict the chroma block unit based on each of the chroma prediction candidates, including the relocated candidates, to generate multiple chroma predicted blocks. The encoder module 114 may select one of the chroma predicted blocks based on a mode selection method, such as a cost function. The mode selection method may be an RDO process, a SAD process, an SATD process, an MAD process, an MSD process, or an SSIM process. The encoder module 114 may provide the selected coding result to the first summer 8142 for generating a chroma residual block and to the second summer 8145 for reconstructing the encoded chroma block unit.

The encoder module 114 may further provide syntax elements, included in the bitstream, for transmitting to the decoder module 124. The syntax elements of the chroma block unit may be used to determine a selected chroma prediction candidate corresponding to the selected chroma predicted block. The syntax elements may include one of a chroma prediction index, or a BVG CCP index.

In some implementations, the encoder module 114 may provide the chroma prediction index when the decoder module 124 selects the chroma prediction mode from the chroma prediction candidates. In some other implementations, the encoder module 114 may provide the BVG CCP index when the encoder module 114 provides other syntax elements to indicate the decoder module 124 to select the chroma prediction mode from the BVG CCP candidates.

In some other implementations, when the selected chroma prediction candidate corresponds to a predefined one of the relocated candidates, the syntax elements, for determining the selected chroma prediction candidate, may be excluded from the bitstream. Thus, the decoder module 124 may directly determine the predefine chroma prediction candidate as the chroma prediction mode without receiving the corresponding syntax element from the bitstream. In some implementations, the predefined relocated candidate may be a predefined one of the relocated BVG CCP candidates. For example, the predefined relocated candidate may be a first determined one of the relocated BVG CCP candidates.

When a specific one of the relocated BVG CCP candidates is selected, the encoder module 114 may predict the chroma block unit using a selected cross-component filter, corresponding to the specific relocated BVG CCP candidate, based on the luma collocated block to generate a chroma predicted block. The encoder module 114 may further determine a scaled luma collocated block of the luma collocated block based on the scaling factor. The encoder module 114 may then predict the chroma block unit, using the cross-component filter, based on the scaled luma collocated block to generate the chroma predicted block.

The encoder module 114 may determine multiple chroma residual components of a chroma residual block for the chroma block unit based on the chroma predicted block. In addition, the encoder module 114 may add the chroma residual components back into the chroma predicted block to reconstruct the chroma block unit. The reconstruction of the block unit by the encoder module 114 may be identical to the reconstruction of the block unit by the decoder module 124. The method/process 600 for the encoder module 114 may then end.

The disclosed implementations are to be considered in all respects as illustrative and not restrictive. It should also be understood that the present disclosure is not limited to the specific disclosed implementations, but that many rearrangements, modifications, and substitutions are possible without departing from the scope of the present disclosure.

What is claimed is:

1. A non-transitory machine-readable medium of an electronic device storing one or more computer-executable instructions for decoding video data, the one or more computer-executable instructions, when executed by at least one processor of the electronic device, causing the electronic device to:
receive the video data;
determine, from an image frame of the video data, a chroma block unit and a luma collocated block that is collocated with the chroma block unit;
determine a first luma collocated vector of the luma collocated block;
determine, from the image frame, a first luma candidate block based on the first luma collocated vector of the luma collocated block;
determine a first luma candidate vector of the first luma candidate block;
determine, from the image frame, a first luma relocated block based on the first luma candidate vector of the first luma candidate block;
determine, from the image frame, a chroma relocated block corresponding to the first luma relocated block;
derive a cross-component filter based on the first luma relocated block and the chroma relocated block; and
reconstruct the chroma block unit based on the luma collocated block using the cross-component filter.

2. The non-transitory machine-readable medium of claim 1, wherein the one or more computer-executable instructions, when executed by at least one processor of the electronic device, further cause the electronic device to:
determine, from the image frame, a second luma candidate block based on the first luma candidate vector of the first luma candidate block;
determine a second luma candidate vector of the second luma candidate block; and
determine, from the image frame, the first luma relocated block further based on the second luma candidate vector of the second luma candidate block.

3. The non-transitory machine-readable medium of claim 1, wherein the first luma candidate vector of the first luma candidate block indicates the first luma relocated block from the first luma candidate block.

4. The non-transitory machine-readable medium of claim 1, wherein deriving the cross-component filter based on the first luma relocated block and the chroma relocated block comprises:
determining a luma scaled block based on the first luma relocated block using one of a down-sampling filter and a sub-sampling filter; and
deriving the cross-component filter based on the luma scaled block and the chroma relocated block.

5. The non-transitory machine-readable medium of claim 1, wherein determining, from the image frame, the chroma relocated block corresponding to the first luma relocated block comprises:
determining a luma relocated vector based on the first luma collocated vector of the luma collocated block and the first luma candidate vector of the first luma candidate block;
determining a chroma relocated vector by scaling the luma relocated vector for determining the cross-component filter; and
determining the chroma relocated block based on the chroma relocated vector.

6. The non-transitory machine-readable medium of claim 1, wherein determining, from the image frame, the chroma relocated block corresponding to the first luma relocated block comprises:
determining, from the image frame, a chroma collocated block, collocated with the first luma relocated block, as the chroma relocated block.

7. The non-transitory machine-readable medium of claim 1, wherein the one or more computer-executable instructions, when executed by the at least one processor, further cause the electronic device to:
determine a second luma candidate vector of the first luma candidate block;
determine, from the image frame, a second luma candidate block based on the second luma candidate vector of the first luma candidate block;
determine a second luma candidate vector of the second luma candidate block; and
determine, from the image frame, a second luma relocated block based on the second luma candidate vector of the second luma candidate block, wherein:
the first luma relocated block and the second luma relocated block are included in a plurality of relocated candidates, and
in a case that the first luma relocated block is selected from the plurality of relocated candidates to reconstruct the chroma block unit, the chroma relocated block is determined based on the first luma relocated block.

8. An electronic device for decoding video data, the electronic device comprising:
at least one processor; and
one or more non-transitory computer-readable media coupled to the at least one processor and storing one or more computer-executable instructions that, when executed by the at least one processor, cause the electronic device to:
receive the video data;
determine, from an image frame of the video data, a chroma block unit and a luma collocated block that is collocated with the chroma block unit;
determine a first luma collocated vector of the luma collocated block;
determine, from the image frame, a first luma candidate block based on the first luma collocated vector of the luma collocated block;
determine a first luma candidate vector of the first luma candidate block;
determine, from the image frame, a first luma relocated block based on the first luma candidate vector of the first luma candidate block;
determine, from the image frame, a chroma relocated block corresponding to the first luma relocated block;
derive a cross-component filter based on the first luma relocated block and the chroma relocated block; and
reconstruct the chroma block unit based on the luma collocated block using the cross-component filter.

9. The electronic device of claim 8, wherein the one or more computer-executable instructions, when executed by at least one processor of the electronic device, further cause the electronic device to:
determine, from the image frame, a second luma candidate block based on the first luma candidate vector of the first luma candidate block;
determine a second luma candidate vector of the second luma candidate block; and
determine, from the image frame, the first luma relocated block further based on the second luma candidate vector of the second luma candidate block.

10. The electronic device of claim 8, wherein the first luma candidate vector of the first luma candidate block indicates the first luma relocated block from the first luma candidate block.

11. The electronic device of claim 8, wherein determining, from the image frame, the chroma relocated block corresponding to the first luma relocated block comprises:
determining a luma relocated vector based on the first luma collocated vector of the luma collocated block and the first luma candidate vector of the first luma candidate block;
determining a chroma relocated vector by scaling the luma relocated vector for determining the cross-component filter; and
determining the chroma relocated block based on the chroma relocated vector.

12. The electronic device of claim 8, wherein determining, from the image frame, the chroma relocated block corresponding to the first luma relocated block comprises:
determining, from the image frame, a chroma collocated block collocated with the first luma relocated block as the chroma relocated block.

13. The electronic device of claim 8, wherein the one or more computer-executable instructions, when executed by the at least one processor, further cause the electronic device to:
determine a second luma candidate vector of the first luma candidate block;
determine, from the image frame, a second luma candidate block based on the second luma candidate vector of the first luma candidate block;
determine a second luma candidate vector of the second luma candidate block; and
determine, from the image frame, a second luma relocated block based on the second luma candidate vector of the second luma candidate block, wherein:
the first luma relocated block and the second luma relocated block are included in a plurality of relocated candidates, and
in a case that the first luma relocated block is selected from the plurality of relocated candidates to reconstruct the chroma block unit, the chroma relocated block is determined based on the first luma relocated block.

14. An electronic device for encoding video data, the electronic device comprising:
at least one processor; and
one or more non-transitory computer-readable media coupled to the at least one processor and storing one or more computer-executable instructions that, when executed by the at least one processor, cause the electronic device to:
receive the video data;
determine, from an image frame of the video data, a chroma block unit and a luma collocated block that is collocated with the chroma block unit;
determine a first luma collocated vector of the luma collocated block;
determine, from the image frame, a first luma candidate block based on the first luma collocated vector of the luma collocated block;
determine a first luma candidate vector of the first luma candidate block;
determine, from the image frame, a first luma relocated block based on the first luma candidate vector of the first luma candidate block;
determine, from the image frame, a chroma relocated block corresponding to the first luma relocated block;
derive a cross-component filter based on the first luma relocated block and the chroma relocated block; and
reconstruct the chroma block unit based on the luma collocated block using the cross-component filter.

15. The electronic device of claim 14, wherein the one or more computer-executable instructions, when executed by at least one processor of the electronic device, further cause the electronic device to:
determine, from the image frame, a second luma candidate block based on the first luma candidate vector of the first luma candidate block;
determine a second luma candidate vector of the second luma candidate block; and
determine, from the image frame, the first luma relocated block further based on the second luma candidate vector of the second luma candidate block.

16. The electronic device of claim 14, wherein the first luma candidate vector of the first luma candidate block indicates the first luma relocated block from the first luma candidate block.

17. The electronic device of claim 14, wherein deriving the cross-component filter based on the first luma relocated block and the chroma relocated block comprises:
determining a luma scaled block based on the first luma relocated block using one of a down-sampling filter and a sub-sampling filter; and
deriving the cross-component filter based on the luma scaled block and the chroma relocated block.

18. The electronic device of claim 14, wherein determining, from the image frame, the chroma relocated block corresponding to the first luma relocated block comprises:
determining a luma relocated vector based on the first luma collocated vector of the luma collocated block and the first luma candidate vector of the first luma candidate block;
determining a chroma relocated vector by scaling the luma relocated vector for determining the cross-component filter; and
determining the chroma relocated block based on the chroma relocated vector.

19. The electronic device of claim 14, wherein determining, from the image frame, the chroma relocated block corresponding to the first luma relocated block comprises:
determining, from the image frame, a chroma collocated block collocated with the first luma relocated block as the chroma relocated block.

20. The electronic device of claim 14, wherein the one or more computer-executable instructions, when executed by the at least one processor, further cause the electronic device to:
determine a second luma candidate vector of the first luma candidate block;
determine, from the image frame, a second luma candidate block based on the second luma candidate vector of the first luma candidate block;
determine a second luma candidate vector of the second luma candidate block; and
determine, from the image frame, a second luma relocated block based on the second luma candidate vector of the second luma candidate block, wherein:
the first luma relocated block and the second luma relocated block are included in a plurality of relocated candidates, and
in a case that the first luma relocated block is selected from the plurality of relocated candidates to reconstruct the chroma block unit, the chroma relocated block is determined based on the first luma relocated block.
